(19) United States
(12) Patent Application Publication
(10) Pub. No.: US 2017/0225480 A1
(43) Pub. Date: Aug. 10, 2017

(54) INK JET HEAD AND INK JET DEVICE

(71) Applicant: Panasonic Intellectual Property Management Co., Ltd., Osaka (JP)

(72) Inventors: TAKASHI HARUGUCHI, Fukuoka (JP); KAZUNARI CHIKANAWA, Kumamoto (JP); TAKAHISA KATO, Kumamoto (JP); HIDEAKI HORIO, Fukuoka (JP); SHINJI TANAKA, Saga (JP)

(21) Appl. No.: 15/410,018

(22) Filed: Jan. 19, 2017

(30) Foreign Application Priority Data
Feb. 5, 2016 (JP) 2016-020412
Feb. 5, 2016 (JP) 2016-020413

(51) Int. Cl. B41J 2/175

(52) U.S. Cl. CPC B41J 2/17563

(57) ABSTRACT

An ink jet head includes a pressure chamber, a main flow path, an actuator, a nozzle, a first communication flow path, and a filter. The pressure chamber is filled with an ink. The main flow path supplies the ink to the pressure chamber. The actuator changes the pressure of the ink filled in the pressure chamber. The nozzle is connected to the pressure chamber and ejects the ink filled in the pressure chamber by driving of the actuator. The first communication flow path connects the pressure chamber to the main flow path. The filter is disposed at a predetermined position between the nozzle and the vicinity of a first boundary of the main flow path and the first communication flow path, and the filter captures an impurity in the ink which has a size larger than the diameter of the nozzle.

### BACKGROUND

1. Technical Field

The present disclosure relates to an ink jet head that ejects an ink on a surface to be printed and an ink jet device using the ink jet head.

2. Description of the Related Art

An ink jet device ejects an ink from an ink jet head to perform printing or drawing on a surface to be printed. The ink jet head incorporated in the ink jet device includes a pressure chamber that is filled with an ink, a flow path for introducing the ink to the pressure chamber, a nozzle connected to the pressure chamber, and an actuator that applies a pressure to the ink filled in the pressure chamber. By driving the actuator to increase the pressure in the pressure chamber, the ink filled in the pressure chamber is ejected from the nozzle (for example, see Unexamined Japanese Patent Publication No. 2005-244174).

### SUMMARY

The ink jet head according to a first aspect of the present disclosure includes a pressure chamber, a main flow path, an actuator, a nozzle, a first communication flow path, and a filter. The pressure chamber is filled with an ink. The main flow path supplies the ink to the pressure chamber. The actuator changes the pressure of the ink filled in the pressure chamber. By driving of the actuator, the nozzle ejects the ink filled in the pressure chamber. The first communication flow path connects the pressure chamber to the main flow path. The filter is disposed at a predetermined position between the nozzle and the vicinity of a first boundary of the main flow path and the first communication flow path, and the filter captures an impurity in the ink which has a size larger than the diameter of the nozzle.

According to the ink jet head of the first aspect of the present disclosure, the impurity in the ink which has a size larger than the diameter of the nozzle is removed from the ink by the filter before reaching the nozzle. Accordingly, it is possible to prevent the nozzle from being clogged with an impurity that has been already mixed with the ink or an impurity that is mixed with the ink during manufacturing of the ink jet head.

The ink jet device according to a second aspect of the present disclosure includes the ink jet head according to the first aspect and an ink supply unit that supplies an ink to the ink jet head.

The ink jet head according to the first aspect is used in the ink jet device according to the second aspect of the present disclosure, and thus it is possible to prevent a nozzle from being clogged with an impurity mixed with the ink and a predetermined amount of the ink can be smoothly ejected from the nozzle. As a result, the performance of the ink jet device can be improved.

As described above, according to the ink jet head and the ink jet device of the present disclosure, it is possible to prevent a nozzle from being clogged with an impurity mixed with an ink.

Effects and significance of the present disclosure will become more apparent from the description of an exemplary embodiment below. However, the exemplary embodiment described below is only an example when the present disclosure is implemented, and the present disclosure is not limited to the following description of the exemplary embodiment.

### BRIEF DESCRIPTION OF THE DRAWINGS

FIG. 1A shows a configuration of an ink jet head according to an exemplary embodiment;

FIG. 1B schematically shows a configuration in which an actuator is combined with a structure body, according to the exemplary embodiment;

FIG. 2A is an enlarged view of a part of the actuator and the structure body according to the exemplary embodiment;

FIG. 2B schematically shows a part of a main flow path and a pressure chamber;

FIG. 2C schematically shows an arrangement of nozzles on the structure body;

FIG. 3 is a partial perspective view of a configuration near the pressure chamber according to the exemplary embodiment;

FIG. 4A is a cross-sectional view schematically showing a configuration near the pressure chamber and a flow of an impurity, according to the exemplary embodiment;

FIG. 4B is a cross-sectional view schematically showing a configuration near a pressure chamber and a flow of an impurity, according to a comparative example;

FIGS. 5A and 5B schematically show overlapping of a pressure chamber and a communication flow path, according to the comparative example;

FIGS. 6A and 6B schematically show overlapping of a pressure chamber and a communication flow path, according to the exemplary embodiment;

FIG. 7 is a block diagram of a configuration of an ink jet device according to the exemplary embodiment;

FIGS. 8A and 8B schematically show overlapping of a pressure chamber and a communication flow path, according to a first variation;

FIG. 9A is a schematic cross-sectional view of a configuration of a communication flow path according to a second variation;

FIG. 9B is a schematic cross-sectional view of a configuration of a communication flow path according to a third variation;

FIGS. 10A and 10B schematically show overlapping of a pressure chamber and an entrance of a communication flow path, according to a fourth variation; and

FIGS. 11A and 11B schematically show overlapping of a pressure chamber and an entrance of a communication flow path, according to a fifth variation.

### DETAILED DESCRIPTION OF EMBODIMENT

In an ink jet head, the diameter of a nozzle is generally set to approximately dozens of micrometers (μm). For this reason, if an impurity having a size larger than the diameter of a nozzle is mixed with an ink, the nozzle is clogged with the impurity and thus the ink may not be ejected smoothly from the nozzle.

In view of the above problems, the present disclosure provides an ink jet head and an ink jet device that can prevent a nozzle from being clogged with an impurity mixed with an ink.

An exemplary embodiment of the present disclosure is described below with reference to the drawings. For convenience, the X, Y, and Z axes that are perpendicular to each other are indicated in the respective drawings. A direction of the Z axis corresponds to a height direction of ink jet head 1 and a positive direction of the Z axis corresponds to a downward direction. A direction of the X axis corresponds to a thickness direction of ink jet head 1 and a direction of the Y axis corresponds to a width direction of ink jet head 1. Ink jet head 1 ejects an ink in the positive direction of the Z axis (the downward direction). The direction of the X axis is an example of “first direction” described in the claims of the present application. The direction of the Y axis is an example of “second direction” described in the claims of the present application.

### Exemplary Embodiment

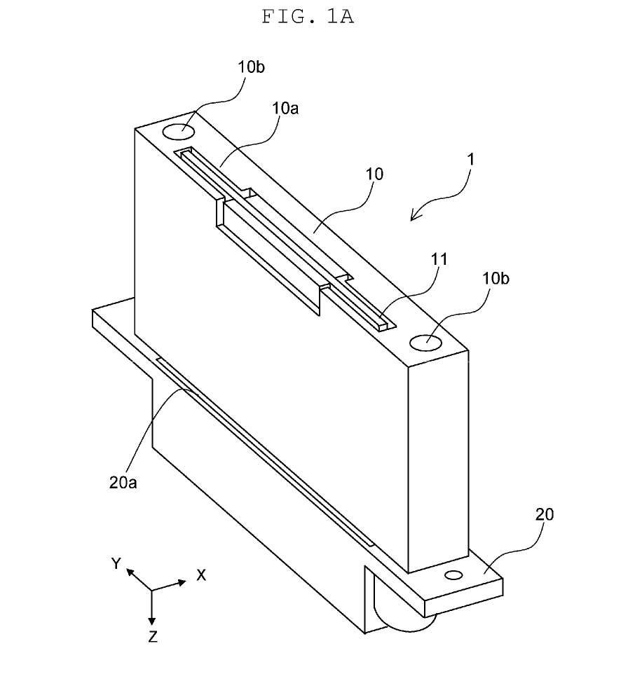

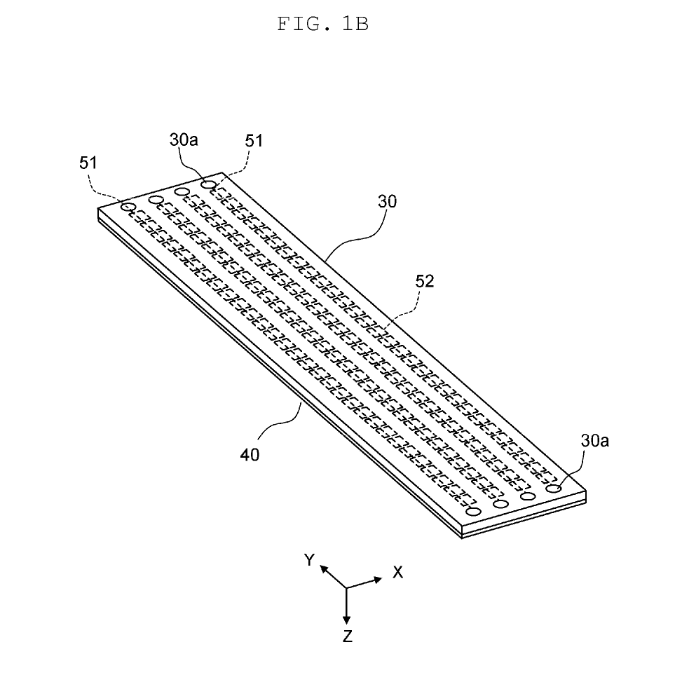

FIG. 1A shows a configuration of ink jet head 1 according to the present exemplary embodiment. FIG. 1B schematically shows a configuration in which actuator 30 is combined with structure body 40, according to the present exemplary embodiment.

As shown in FIG. 1A, ink jet head 1 includes housing box 10 and head base 20. Housing box 10 is detachably attached to head base 20.

Housing box 10 is formed of a rectangular parallelepiped box with its lower surface open. Cutout 10a connected to the inside of housing box 10 is formed in an upper surface thereof, and circuit board 11 is accommodated in housing box 10 through cutout 10a. A drive circuit for driving actuator 30 is mounted on circuit board 11. Circular holes 10b are respectively formed on positive and negative sides of the Y axis with respect to cutout 10a. Holes 10b are used for introducing ink supply tubes (not shown) to the inside of housing box 10.

Head base 20 is formed of a frame body that has vertically-open rectangular parallelepiped opening 20a at its center portion. Actuator 30 and structure body 40 shown in FIG. 1B are installed on a lower end of opening 20a. Actuator 30 is electrically connected to circuit board 11 in opening 20a by FPC (Flexible Printed Circuits).

As shown in FIG. 1B, actuator 30 is formed of a rectangular plate. Actuator 30 is stacked on an upper surface of structure body 40. Structure body 40 is also formed of a rectangular plate. Four main flow paths 51 disposed side by side in the direction of the X axis are formed in structure body 40.

Four ink supply ports 30a are formed near an end of actuator 30 on the positive side of the Y axis. Four ink supply ports 30a are also formed near an end of actuator 30 on the negative side of the Y axis. Four ink supply ports 30a are disposed side by side in the direction of the X axis. Both of two ink supply ports 30a disposed side by side in the direction of the Y axis are connected to one independent main flow path 51.

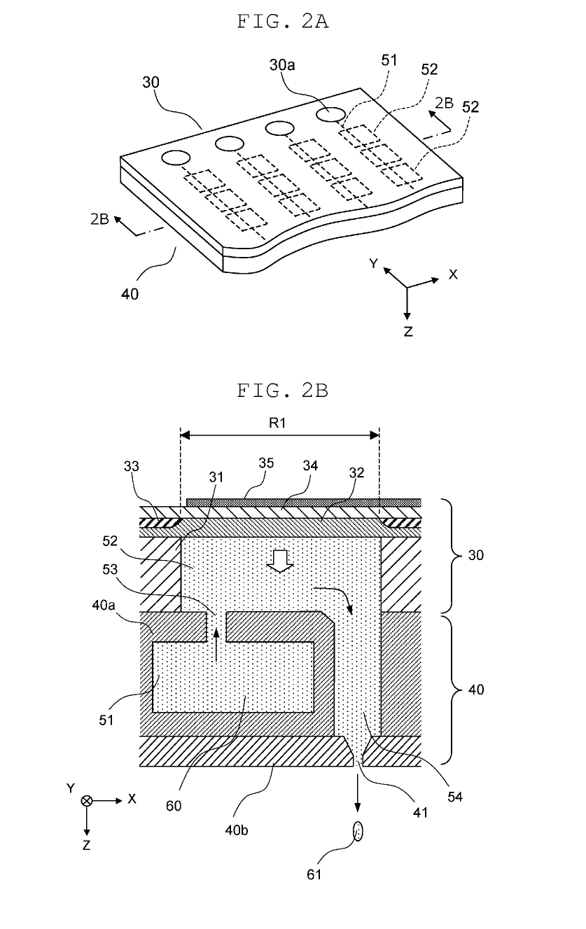

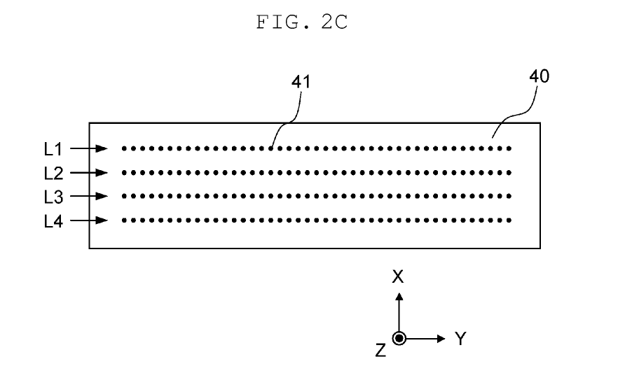

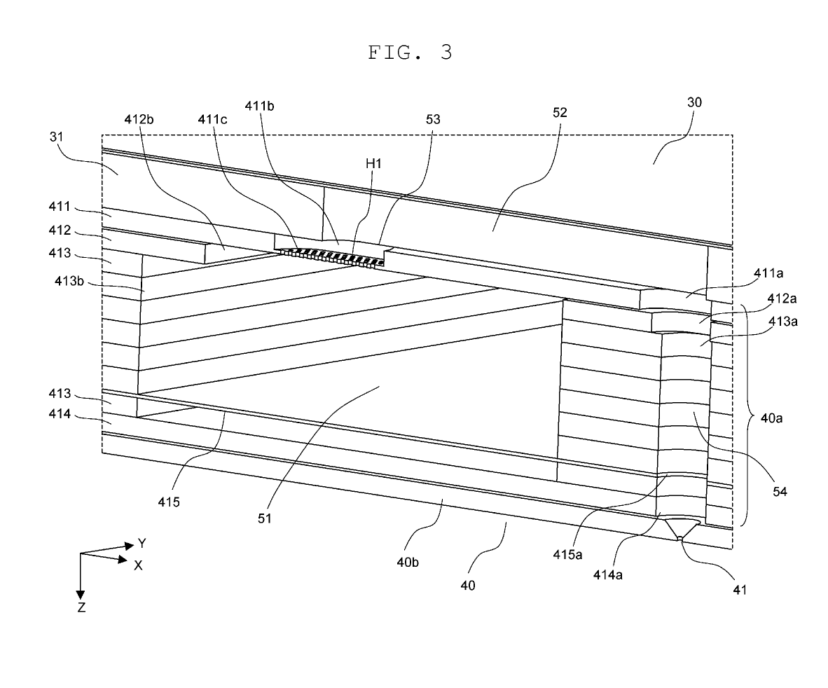

FIG. 2A is an enlarged view of the vicinity of an end of the configuration shown in FIG. 1B on the positive side of the Y axis. A groove (a recessed part) is formed in a rear surface of actuator 30 (a surface facing structure body 40). As actuator 30 is stacked on structure body 40, pressure chamber 52 is formed between the groove (the recessed part) formed in the rear surface of actuator 30 and the upper surface of structure body 40 (a surface facing actuator 30). Pressure chamber 52 is connected via communication flow path 53 formed in structure body 40 to main flow path 51 (see FIG. 2B).

A terminal group (not shown) for connecting the FPC of circuit board 11 is formed at each of ends of an upper surface of actuator 30 on the positive and negative sides of the X axis. The terminal groups are used for applying a voltage (a drive signal) to piezoelectric body layer 34 (see FIG. 2B) of actuator 30.

As described above, an end of main flow path 51 is connected to ink supply port 30a. A large number of pressure chambers 52 are disposed along main flow path 51, and communication flow path 53 (see FIG. 2B) is provided for each of pressure chambers 52. Each pressure chamber 52 is connected to main flow path 51 via communication flow path 53 (see FIG. 2B).

Returning to FIG. 1B, a pipe (not shown) is fitted into each of eight ink supply ports 30a and an ink is supplied from an ink supply tube (not shown) to each of the pipes. The pipe is supported by a support member placed in opening 20a and the ink supply tube is drawn outside through hole 10b. The ink is supplied to ink supply port 30a through the ink supply tube and the pipe. The ink thus flows in main flow path 51 and communication flow path 53 and is supplied to pressure chamber 52.

An ink of the same color is supplied to two ink supply ports 30a disposed side by side in the direction of the Y axis. On the other hand, inks of different colors are supplied to four ink supply ports 30a disposed side by side in the direction of the X axis. Accordingly, in the configuration of FIG. 1B, four color inks are supplied to actuator 30. Thus, pressure chambers 52 disposed side by side in the direction of the Y axis are filled with an ink of the same color. On the other hand, pressure chambers 52 disposed side by side in the direction of the X axis are filled with inks of different colors. A unit of actuator 30 and structure body 40 is installed on the lower end of opening 20a of head base 20. The four color inks are thus ejected from a lower surface of head base 20.

FIG. 2B is a cross-sectional view schematically showing a cross-section obtained by cutting the vicinity of pressure chamber 52 on the positive side (the right side) of the X axis shown in FIG. 2A at a center position of pressure chamber 52 in the direction of the Y axis (line 2B-2B) along a plane parallel to a plane X-Y.

Ink 60 having flown into main flow path 51 passes through communication flow path 53 (first communication flow path) to be filled in pressure chamber 52. Structure body 40 is constituted by upper member 40a that includes main flow path 51 and communication flow paths 53, 54, and lower member 40b that includes nozzle 41. Nozzle 41, which is a hole, is formed at a part of lower member 40b corresponding to communication flow path 54 (second communication flow path) extending from pressure chamber 52 in the positive direction of the Z axis. Nozzle 41 includes a substantially conical part whose diameter is gradually reduced from an upper surface of lower member 40b (a surface facing upper member 40a) toward the positive direction of the Z axis and a substantially cylindrical part that has a fixed diameter and is provided near an exit (a lower surface of lower member 40b). In the following explanations, the diameter of nozzle 41 means the diameter of the cylindrical part.

Actuator 30 is constituted by pressure chamber layer 31, and successively stacking diaphragm layer 32, insulating layer 33, piezoelectric body layer 34, and electrode layer 35 on pressure chamber layer 31. Diaphragm layer 32, insulating layer 33, piezoelectric body layer 34, and electrode layer 35 are formed by using a vacuum film forming technique such as sputtering. Alternatively, these layers can be formed by using other film forming techniques such as coating. Pressure chamber layer 31 is formed by using a thick film forming technique such as plating or by etching a metallic plate. Pressure chamber 52 is formed by attaching upper member 40a to a lower surface of pressure chamber layer 31. Diaphragm layer 32 is made of a conductive metallic material and also functions as a lower electrode (a common electrode) of piezoelectric body layer 34. Insulating layer 33 is formed in an area other than piezoelectric functional region R1 and insulates piezoelectric body layer 34 from diaphragm layer 32. That is, in the area other than piezoelectric functional region R1, insulating layer 33 blocks application of a voltage to piezoelectric body layer 34.

Piezoelectric body layer 34 is made of, for example, lead zirconate titanate (PZT). Piezoelectric body layer 34 has a film thickness of a few micrometers (μm). Electrode layer 35 is made of a conductive material. Electrode layer 35 is made of, for example, titanium containing a noble metal. Electrode layer 35 has a film thickness of approximately 0.2 μm.

When a voltage is applied to electrode layer 35, piezoelectric body layer 34 in piezoelectric functional region R1 is deformed in the direction of the Z axis and thus diaphragm layer 32 is also deformed. When diaphragm layer 32 in piezoelectric functional region R1 is deformed downward, the capacity of pressure chamber 52 decreases and the pressure of ink 60 filled in pressure chamber 52 increases. Droplet 61 of ink 60 is thus ejected from nozzle 41.

Each of pressure chamber layer 31, diaphragm layer 32, insulating layer 33, piezoelectric body layer 34, and electrode layer 35 are not necessarily formed as a single layer, and each of these layers can be constituted by a plurality of layers. Other layers can be further disposed between these layers.

FIG. 2C schematically shows an arrangement of nozzles 41 on structure body 40.

As shown in FIG. 2C, a plurality of nozzles 41 are disposed in a line on structure body 40. Four lines L1 to L4 of nozzles 41 are disposed on structure body 40. For example, 200 nozzles 41 are provided in each of lines L1 to L4 at fixed intervals. The number of nozzles 41 in each line is not limited to 200.

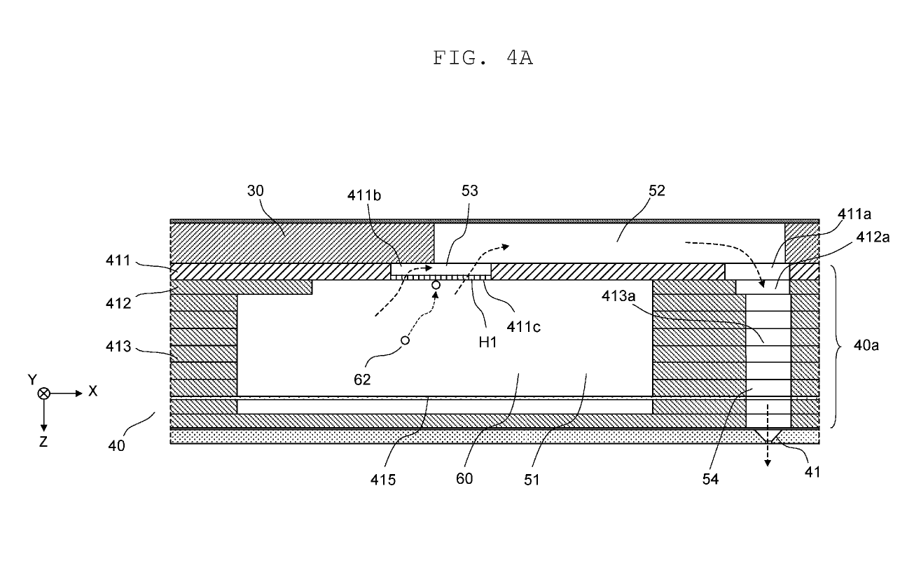

FIG. 3 is a partial perspective view showing a configuration near pressure chamber 52.

As shown in FIG. 3, upper member 40a of structure body 40 is constituted by stacking plate-like body 411, plate-like body 412, seven plate-like bodies 413, and plate-like body 414. Each of plate-like bodies 411 to 414 has a predetermined thickness and has the same outline as that of structure body 40 in plan view. Seven plate-like bodies 413 have the same configuration. Thin dumper 415 is interposed between first plate-like body 413 disposed first from the bottom and second plate-like body 413 disposed second from the bottom. Damper 415 is used for absorbing pressure waves applied from communication flow path 53 to main flow path 51 when actuator 30 is driven to deform diaphragm layer 32 downward (in the positive direction of the Z axis). “In plan view” means a view from a position vertically above an upper surface of upper member 40a of structure body 40 (a connecting surface of pressure chamber 52 and communication flow path 53) and has substantially the same meaning as “on a plane X-Y” (this is also applicable to the following explanations).

Oblong holes 411a, 412a for forming communication flow path 54 are formed in plate-like bodies 411, 412, respectively. The longitudinal direction of oblong holes 411a, 412a is the direction of the X axis. In plan view, oblong holes 411a, 412a have an oval outline which is long in the direction of the X axis. Specifically, oblong hole 411a has an outline obtained by connecting ends of two opposing semi-circular arcs by straight lines. Oblong hole 412a has an outline obtained by connecting the ends of the two opposing semi-circular arcs identical to those of oblong hole 411a by straight lines shorter than those of oblong hole 411a.

Holes 413a for forming communication flow path 54 are formed in seven plate-like bodies 413. Each hole 413a has a substantially circular outline. Holes 414a, 415a for forming communication flow path 54 are also formed in plate-like body 414 and damper 415, respectively. The diameter of holes 414a, 415a is substantially equal to that of hole 413a. The center positions of seven holes 413a are identical to each other on a plane X-Y. The center positions of holes 414a, 415a are identical to those of holes 413a on a plane X-Y. The center position of nozzle 41 is identical to those of holes 413a, 414a, 415a on a plane X-Y.

The center position of oblong hole 412a is identical to those of holes 413a in the direction of the Y axis, but is shifted from the center positions of holes 413a in the negative direction of the X axis. The center position of oblong hole 411a is identical to that of oblong hole 412a in the direction of the Y axis, but is shifted from the center position of oblong hole 412a in the negative direction of the X axis. In plan view (on a plane X-Y), edges of oblong holes 411a, 412a at the positive side of the X axis are identical to those of holes 413a at the positive side of the X axis.

Opening 412b is formed in a part of plate-like body 412 at an area corresponding to main flow path 51, and opening 413b is formed in a part of plate-like body 413 at an area corresponding to main flow path 51. The width of opening 412b in the direction of the X axis is narrower than that of opening 413b. In plan view (on a plane X-Y), an edge of opening 412b at the positive side of the X axis is identical to that of the opening 413b. Main flow path 51 is divided into two portions by damper 415.

Opening 411b is formed in a part of plate-like body 411 at an area corresponding to communication flow path 53. Filter 411c is formed at a lower end of opening 411b (an entrance of communication flow path 53). That is, filter 411c is formed near a boundary of main flow path 51 and communication flow path 53. A large number of holes H1 each having a diameter of a few micrometers (μm) are formed in filter 411c. The diameter of holes H1 formed in filter 411c is slightly smaller than that of the exit of nozzle 41. For example, the diameter of the exit of nozzle 41 is 20 μm, and the diameter of holes H1 in filter 411c is 15 μm. In plan view, opening 411b has a hexagonal outline which is long in the direction of the X axis. Alternatively, opening 411b may have the oval outline which is long in the direction of the X axis, for example, the outline obtained by connecting ends of two opposing semi-circular arcs by straight lines.

Oblong holes 411a, 412a and opening 411b that are described above may be formed in a large circular shape so as to have approximately a diameter equal to a length of a long axis. If oblong holes 411a, 412a and opening 411b are formed in a large circular shape, however, the pitch of nozzle 41 in the direction of the Y axis increases so that high density printing is hindered. Accordingly, it is preferable to form oblong holes 411a, 412a and opening 411b in an oblong shape, as described above.

Opening 411b is disposed to be shifted from pressure chamber 52 in the direction of the X axis such that a part of opening 411b on the positive side of the X axis in plan view overlaps pressure chamber 52 and a part of opening 411b on the negative side of the X axis in plan view does not overlap pressure chamber 52. Filter 411c is disposed over the entire area of the entrance of communication flow path 53. A clearance is thus formed between a part of filter 411c on the negative side of the X axis and a lower surface of pressure chamber layer 31, and this clearance functions as a flow path of ink 60.

In the part of opening 411b on the negative side of the X axis, ink 60 having flown from main flow path 51 through filter 411c flows through the clearance between filter 411c and the lower surface of pressure chamber layer 31 to enter pressure chamber 52 through the part of opening 411b on the positive side of the X axis. When actuator 30 is driven to increase the pressure of pressure chamber 52, ink 60 filled in pressure chamber 52 flows in communication flow path 54 constituted by oblong holes 411a, 412a, and holes 413a, 414a, 415a to be ejected from nozzle 41.

As shown in FIG. 3, according to the present exemplary embodiment, upper member 40a of structure body 40 is constituted by stacking plate-like bodies 411, 412, 413, 414. Lower member 40b is bonded to a lower surface of upper member 40a or is joined to the lower surface of upper member 40a by thermal diffusion. Upper member 40a is bonded to the lower surface of pressure chamber layer 31, thereby forming structure body 40. Further, structure body 40 constituted by upper member 40a and lower member 40b is attached to actuator 30. That is, by attaching structure body 40 having communication flow path 54 to actuator 30, pressure chamber 52 is connected to communication flow path 54. At this time, pressure chamber 52 is also connected to communication flow path 53.

Meanwhile, in an ink jet head, fine dust adhering to main flow path 51 of structure body 40 or an impurity such as a fragment of structure body 40 may be mixed with ink 60 flowing in main flow path 51. Alternatively, an impurity may be already contained in ink 60. In these cases, if the size of the impurity is larger than the diameter of the exit of nozzle 41, nozzle 41 is clogged with the impurity having reached nozzle 41 and ink 60 may not be smoothly ejected from nozzle 41.

To handle such a problem, according to the present exemplary embodiment, filter 411c is provided at the entrance of communication flow path 53. Accordingly, even if an impurity having a size larger than the diameter of nozzle 41 is mixed with ink 60 flowing in main flow path 51, it is possible to prevent nozzle 41 from being clogged with the impurity. The effects of filter 411c are explained below.

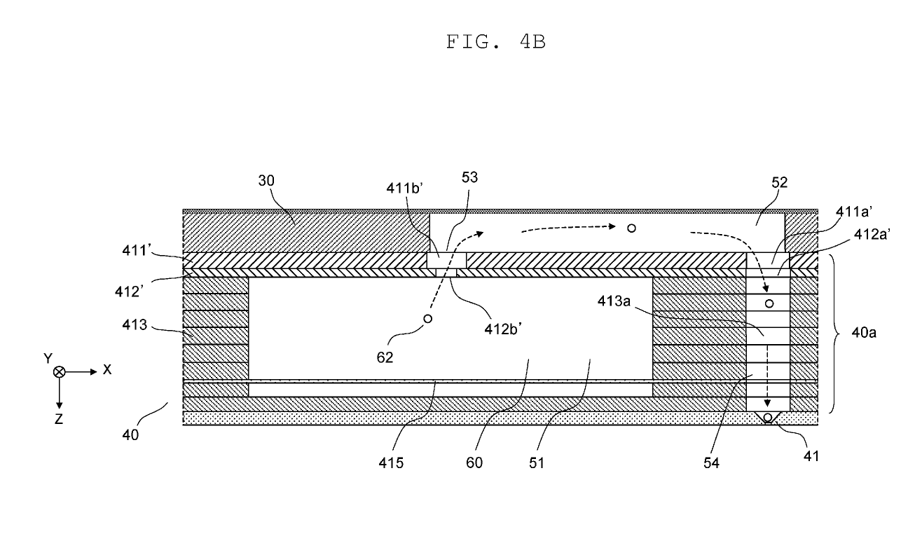

FIG. 4A is a cross-sectional view schematically showing a configuration near pressure chamber 52 and a flow of an impurity, according to the present exemplary embodiment. FIG. 4B is a cross-sectional view schematically showing a configuration near pressure chamber 52 and a flow of an impurity, according to a comparative example. FIGS. 4A and 4B each show a cross-section obtained by cutting actuator 30 and structure body 40 at a center position of the width of pressure chamber 52 in the direction of the Y axis (a position corresponding to line 2B-2B of FIG. 2A) along a plane parallel to a plane X-Z.

A configuration of top plate-like body 411′ and second plate-like body 412′ in the comparative example shown in FIG. 4B is different from that in the present exemplary embodiment shown in FIG. 4A. That is, in the comparative example, cylindrical holes 411a′, 412a′ having the same diameter as that of each of holes 413a formed in plate-like bodies 413 are formed in top plate-like body 411′ and second plate-like body 412′, respectively. The center positions of holes 411a′, 412a′ are identical to those of holes 413a on a plane X-Y. In this way, communication flow path 54 is configured. Further, in the comparative example, cylindrical holes 411b′, 412b′ constituting communication flow path 53 are formed in top plate-like body 411′ and second plate-like body 412′, respectively. The diameter of hole 412b′ is set to be smaller than that of hole 411b′.

According to the configuration of the comparative example, when impurity 62 is mixed with ink 60 flowing in main flow path 51, impurity 62 flows in communication flow path 53 constituted by holes 411b′, 412b′ to enter pressure chamber 52. Impurity 62 then flows in communication flow path 54 and reaches nozzle 41. Nozzle 41 is thus clogged with impurity 62 and may not be capable of ejecting ink 60.

On the other hand, according to the present exemplary embodiment, as shown in FIG. 4A, filter 411c having a large number of circular holes H1 is disposed over the entire area of the entrance of communication flow path 53. The diameter of each of holes H1 formed in filter 411c is set to be smaller than that of the exit of nozzle 41. Accordingly, even if impurity 62 having a size larger than the diameter of the exit of nozzle 41 is mixed with ink 60 flowing in main flow path 51, impurity 62 is blocked by filter 411c and does not enter pressure chamber 52. It is thus possible to prevent nozzle 41 from being clogged with impurity 62.

Impurity 62 having a size smaller than the diameter of each of holes H1 in filter 411c passes through filter 411c and reaches nozzle 41. However, since impurity 62 has a size smaller than the diameter of the exit of nozzle 41, impurity 62 is discharged outside together with ink 60 when ink 60 is ejected from nozzle 41.

According to the present exemplary embodiment, it is possible to reliably prevent nozzle 41 from being clogged with impurity 62.

According to the present exemplary embodiment, oblong holes 411a, 412a are formed in first plate-like body 411 and second plate-like body 412 from a side of pressure chamber 52, respectively. Further, oblong holes 411a, 412a are longer in the direction of the X axis than other holes 413a, 414a of plate-like bodies 413, 414. Accordingly, even if slight misalignment occurs between structure body 40 and actuator 30 at the time of bonding structure body 40 to actuator 30, it is possible to prevent the area of communication flow path 54 overlapping pressure chamber 52 from being significantly reduced.

Similarly, opening 411b formed as communication flow path 53 has an oblong shape which is long in the direction of the X axis. Accordingly, even if slight misalignment occurs between structure body 40 and actuator 30 at the time of bonding structure body 40 to actuator 30, it is possible to prevent the area of communication flow path 53 overlapping pressure chamber 52 from being significantly reduced.

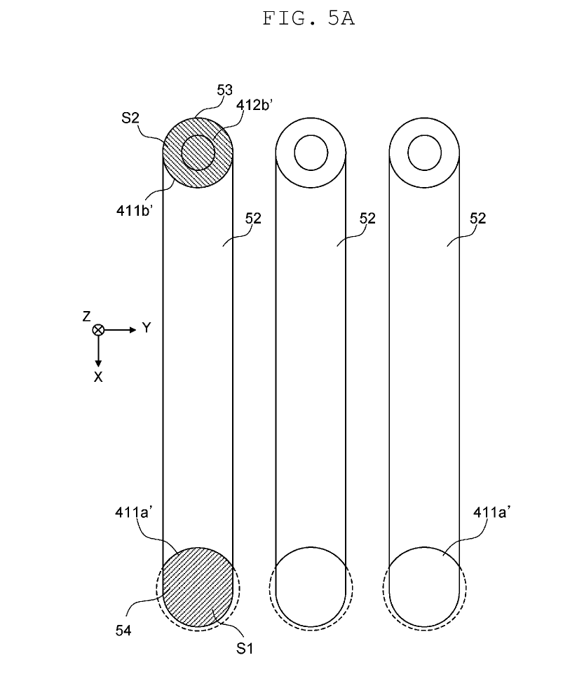

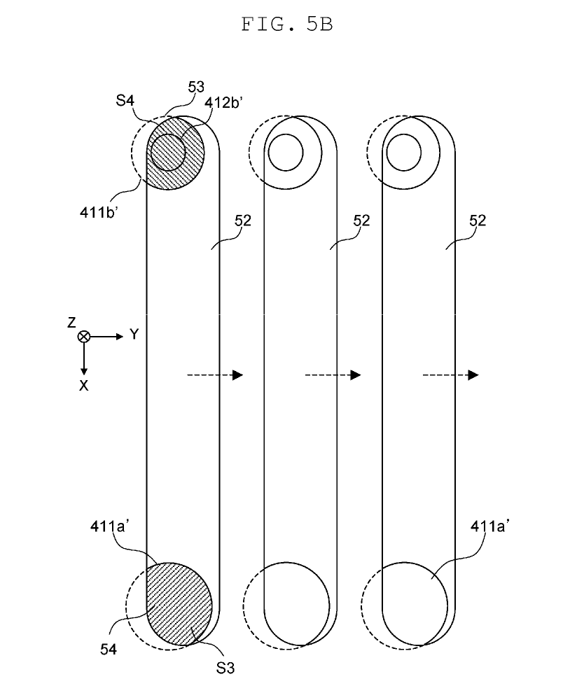

FIGS. 5A and 5B schematically show overlapping of pressure chamber 52 and communication flow paths 53, 54 according to the comparative example. FIGS. 5A and 5B show pressure chamber 52 as perspectively viewed from a positive side of the Z axis. For convenience, FIGS. 5A and 5B show three patterns of overlapping of pressure chamber 52 and communication flow paths 53, 54.

As shown in FIG. 5A, when structure body 40 is bonded to actuator 30 without any misalignment, area S1 of communication flow path 54 overlapping pressure chamber 52 in plan view is properly secured. Area S2 of communication flow path 53 overlapping pressure chamber 52 in plan view is also properly secured.

As shown in FIG. 5B, however, when misalignment in the direction of the Y axis occurs between structure body 40 and actuator 30 at the time of bonding structure body 40 to actuator 30, area S3 of communication flow path 54 overlapping pressure chamber 52 in plan view decreases from normal area S1, and area S4 of communication flow path 53 overlapping pressure chamber 52 in plan view also decreases from normal area S2. As a result, an ink hardly flows from communication flow path 53 to pressure chamber 52. Further, an ink hardly flows from pressure chamber 52 to communication flow path 54.

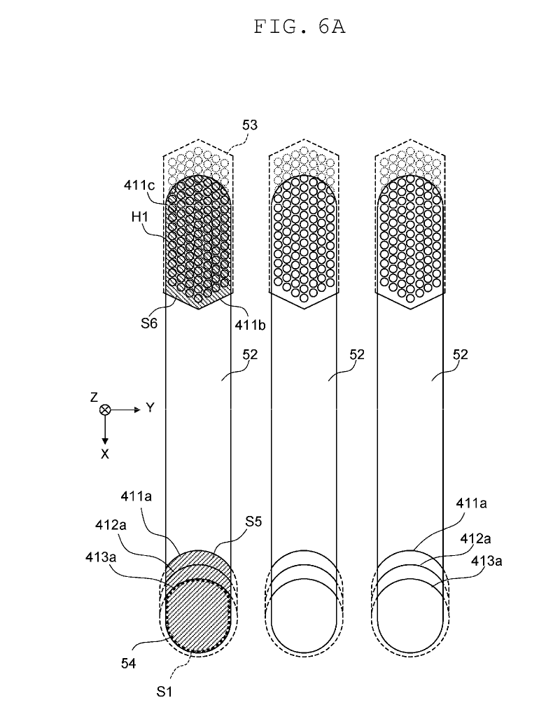

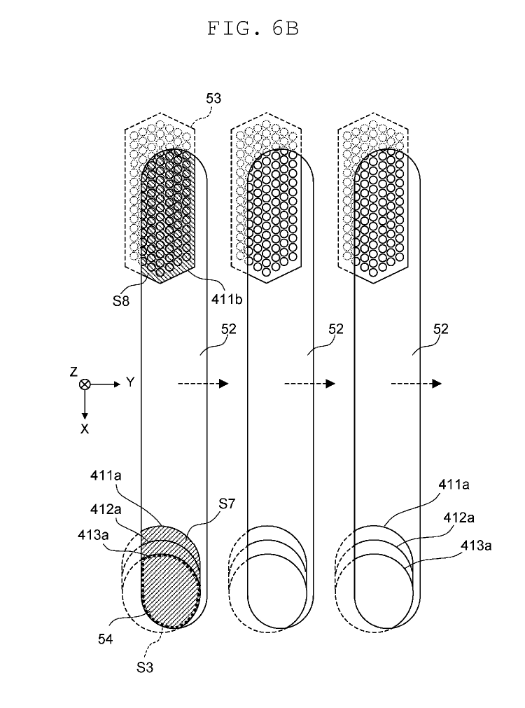

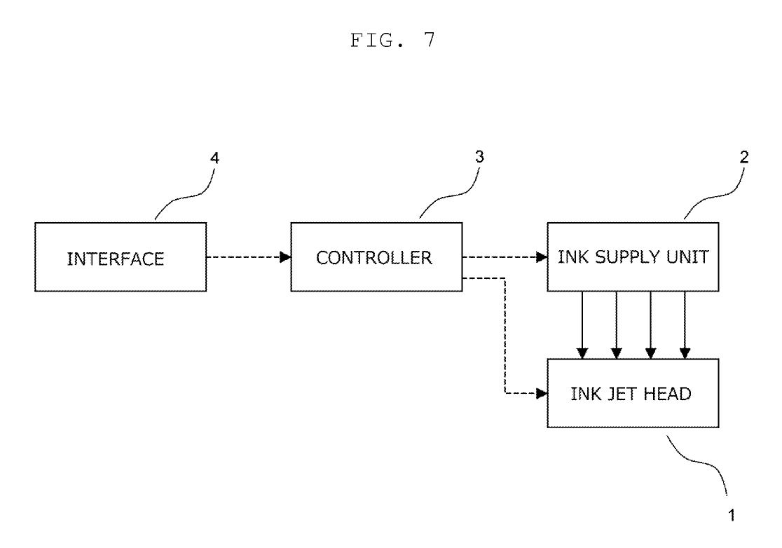

FIGS. 6A and 6B schematically show overlapping of pressure chamber 52 and communication flow paths 53, 54 according to the present exemplary embodiment. Similar to FIGS. 5A and 5B, FIGS. 6A and 6B show pressure chamber 52 as perspectively viewed from the positive side of the Z axis. Further, FIGS. 6A and 6B also show three patterns of overlapping of pressure chamber 52 and the entrance of communication flow path 54. With respect to communication flow path 54 shown in FIGS. 6A and 6B, an area where hole 413a constituting communication flow path 54 overlaps pressure chamber 52 is surrounded by broken lines, and hatching is applied to an area where oblong hole 411a constituting communication flow path 54 overlaps pressure chamber 52.

As shown in FIG. 6A, when structure body 40 is bonded to actuator 30 without any misalignment, it is possible to secure a large area of communication flow path 54 overlapping pressure chamber 52 in plan view. Area S1 of holes 413a, 414a, 415a connected to nozzle 41 (see FIG. 3) overlapping pressure chamber 52 in plan view is equal to area S1 according to the comparative example shown in FIG. 5A. That is, the area of an opening of communication flow path 54 in a boundary of nozzle 41 and communication flow path 54 is equal to area S1. Meanwhile, as described above, according to the present exemplary embodiment, oblong holes 411a, 412a formed in first plate-like body 411 and second plate-like body 412 from the side of pressure chamber 52 (a boundary of pressure chamber 52 and communication flow path 54) are extended in the direction of the X axis as compared to hole 413a. Accordingly, area S5 of oblong hole 411a overlapping pressure chamber 52 in plan view is larger than area S1 according to the comparative example shown in FIG. 5A. Further, according to the present exemplary embodiment, opening 411b is extended in the direction of the X axis, and thus area S6 of opening 411b overlapping pressure chamber 52 in plan view is larger than area S2 according to the comparative example shown in FIG. 5A.

As shown in FIG. 6B, when misalignment in the direction of the Y axis occurs between structure body 40 and actuator 30 at the time of bonding structure body 40 to actuator 30, area S3 of a mainstream portion of communication flow path 54 (hole 413a) overlapping pressure chamber 52 in plan view decreases from normal area S1. Nevertheless, a large opening in the boundary of communication flow path 54 and pressure chamber 52 is secured. That is, large area S7 of oblong hole 411a overlapping pressure chamber 52 in plan view is secured. Further, large area S8 of communication flow path 53 (opening 411b) overlapping pressure chamber 52 in plan view is secured. For this reason, an ink is smoothly introduced from communication flow path 53 to pressure chamber 52 and then from pressure chamber 52 to communication flow path 54. As a result, even if such misalignment occurs, a predetermined amount of an ink can be smoothly ejected from nozzle 41.

While it is assumed in the above explanation that pressure chamber 52 is shifted in the direction of the Y axis, the same effects can be obtained when pressure chamber 52 is shifted in the direction of the X axis perpendicular to the direction of the Y axis.

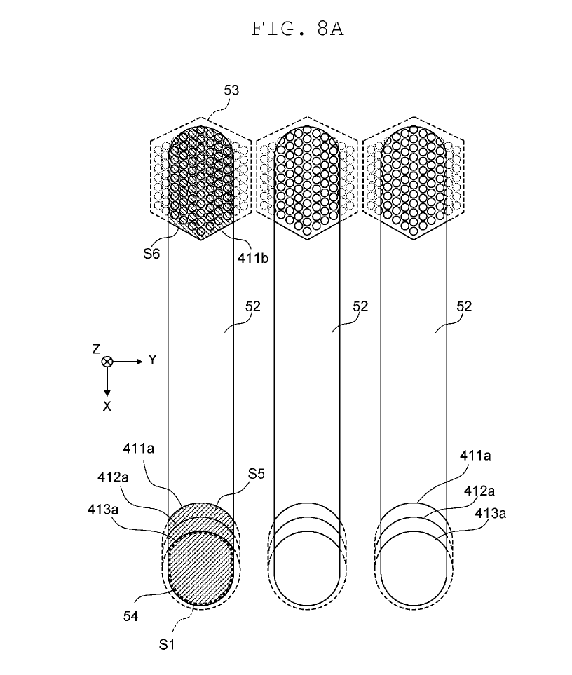

FIG. 7 is a block diagram of a configuration of an ink jet device according to the present exemplary embodiment.

The ink jet device includes, in addition to ink jet head 1 with the configuration described above, ink supply unit 2, controller 3, and interface 4.

Ink supply unit 2 includes the above-described tube for supplying an ink to ink jet head 1 (the ink supply tube), an ink tank connected to the ink supply tube, and a pump for supplying an ink from the ink tank to the ink supply tube. Controller 3 includes a CPU and a memory and controls ink jet head 1 and ink supply unit 2 according to a program stored in a memory. Interface 4 accepts an input of drawing information such as a character and a graphic to be printed and outputs the drawing information to controller 3.

Controller 3 controls ink jet head 1 according to the input drawing information to perform printing or drawing on a surface to be printed. In this way, an ink is ejected from nozzles 41 corresponding to a print image onto a surface to be printed, and printing and drawing are performed on the surface to be printed.

### Effects of Exemplary Embodiment

According to the present exemplary embodiment, the following effects are obtained.

As described with reference to FIG. 4A, when impurity 62 having a size larger than the diameter of nozzle 41 is contained in ink 60, impurity 62 is removed from ink 60 by filter 411c before reaching nozzle 41. Accordingly, it is possible to prevent nozzle 41 from being clogged with impurity 62 that has been already mixed with ink 60 or impurity 62 that is mixed with ink 60 in manufacturing of ink jet head 1.

As shown in FIG. 3, filter 411c has a large number of holes H1 each having a diameter smaller than that of nozzle 41, and thus impurity 62 having a size larger than the diameter of nozzle 41 can be reliably blocked.

If impurity 62 is mixed with ink 60, impurity 62 may adhere to a lower surface of filter 411c. According to the present exemplary embodiment, however, a part of ink 60 in pressure chamber 52 flows backward from communication flow path 53 to main flow path 51 by a pressure applied to pressure chamber 52 by actuator 30 when ink 60 is ejected from nozzle 41. With this flow of ink 60, impurity 62 adhering to the lower surface of filter 411c is removed from filter 411c. As a result, it is possible to prevent filter 411c from being clogged with impurity 62, and a flow of ink 60 from main flow path 51 to pressure chamber 52 is secured.

According to the present exemplary embodiment, filter 411c functions as a resistance to a backward flow of ink 60 from pressure chamber 52 to main flow path 51, and thus the pressure in pressure chamber 52 hardly escapes through communication flow path 53 to main flow path 51. Accordingly, even when the area of the opening of communication flow path 53 increases as shown in FIGS. 3 and 4A, the pressure in pressure chamber 52 can be properly applied to nozzle 41. As a result, by increasing the area of communication flow path 53 to increase the area of filter 411c, ink 60 can be smoothly supplied from main flow path 51 to pressure chamber 52 while properly maintaining the pressure applied to nozzle 41.

According to the present exemplary embodiment, a pressure wave transmitted from pressure chamber 52 to main flow path 51 at the time of driving actuator 30 is absorbed by filter 411c. It is thus possible to effectively prevent this pressure wave from being reflected by damper 415 and entering pressure chamber 52 again. As a result, an undesirable pressure variation in pressure chamber 52 due to the pressure wave can be prevented and an operation of ejecting an ink by actuator 30 can be performed more accurately.

As shown in FIGS. 3 and 4A, communication flow path 53 is disposed to be shifted from pressure chamber 52 in the direction of the X axis such that a part of communication flow path 53 on the positive side of the X axis in plan view overlaps pressure chamber 52 and a part of communication flow path 53 on the negative side of the X axis in plan view does not overlap pressure chamber 52. Filter 411c is disposed over the entire area of the entrance of communication flow path 53. A clearance is thus formed between a part of filter 411c on the negative side of the X axis and a lower surface of pressure chamber layer 31, and ink 60 can be introduced from the part of filter 411c on the negative side of the X axis via this clearance to pressure chamber 52. The flow amount of ink 60 flowing through filter 411c can be increased by securing the increased area of filter 411c. Further, by reducing the area of communication flow path 53 overlapping pressure chamber 52, it is possible to prevent the pressure in pressure chamber 52 from escaping from communication flow path 53 to main flow path 51. As a result, ink 60 can be smoothly introduced from main flow path 51 to pressure chamber 52, and the same time, ink 60 can be properly ejected by the pressure applied to pressure chamber 52.

As shown in FIGS. 6A and 6B, the width of pressure chamber 52 and communication flow path 53 in the direction of the X axis (first direction) is larger than the width in the direction of the Y axis (second direction) perpendicular to the direction of the X axis (first direction). Communication flow path 53 is disposed to be shifted from pressure chamber 52 in the direction of the X axis (first direction). Accordingly, as shown in FIG. 6B, even if misalignment in the direction of the Y axis occurs between structure body 40 and actuator 30 at the time of bonding structure body 40 to actuator 30, large area S8 of communication flow path 53 (opening 411b) overlapping pressure chamber 52 in plan view is secured. Further, even if misalignment in the direction of the X axis occurs between structure body 40 and actuator 30, a large area of communication flow path 53 (opening 411b) overlapping pressure chamber 52 in plan view is secured. Ink 60 is thus smoothly introduced from communication flow path 53 to pressure chamber 52 and then from pressure chamber 52 to communication flow path 54. As a result, even if such misalignment occurs, a predetermined amount of ink 60 can be smoothly ejected from nozzle 41.

As shown in FIGS. 3, 6A, and 6B, according to the present exemplary embodiment, a set of pressure chamber 52, communication flow path 54, and nozzle 41 (nozzle set) is disposed side by side in the direction of the Y axis (second direction). An end of communication flow path 54 on a side of pressure chamber 52 (an opening in a boundary of communication flow path 54 and pressure chamber 52) is extended in the direction of the X axis (first direction) perpendicular to the direction of the Y axis (second direction) along which the set of pressure chamber 52, communication flow path 54, and nozzle 41 is disposed side by side. Accordingly, even if the distance between the nozzles 41 is short, the distance between entrances (openings) of adjacent communication flow paths 54 is not significantly reduced. As a result, even if structure body 40 is bonded to actuator 30 to be shifted therefrom in the direction of the Y axis, it is possible to prevent the entrance (the opening) of communication flow path 54 from being placed over (overlapping) pressure chamber 52 in the next nozzle set.

As shown in FIG. 3, the end of communication flow path 54 on the side of pressure chamber 52 becomes large toward pressure chamber 52. That is, the opening of communication flow path 54 becomes large toward pressure chamber 52. For this reason, a flow of ink 60 is hardly hindered at the entrance of communication flow path 54 and thus ink 60 can be smoothly introduced from pressure chamber 52 to the mainstream portion of communication flow path 54.

As shown in FIG. 3, according to the present exemplary embodiment, structure body 40 is constituted by stacking plate-like bodies 411, 412, 413, 414. Oblong holes 411a, 412a and holes 413a, 414a that constitute parts of communication flow path 54 are formed in plate-like bodies 411, 412, 413, 414, respectively. Oblong holes 411a, 412a of first plate like body 411 and second plate-like body 412 from the side of pressure chamber 52 (the boundary of pressure chamber 52 and communication flow path 54) are larger than holes 413a, 414a of plate-like bodies 413, 414. By forming holes of plate-like bodies 411, 412 on the side of the entrance of communication flow path 54 as oblong holes 411a, 412a, the width of the entrance of communication flow path 54 can be easily increased.

In such a case, as shown in FIG. 3, oblong holes 411a, 412a of first and second plate-like bodies 411, 412 from the side of pressure chamber 52 (the boundary of pressure chamber 52 and communication flow path 54) are formed to become larger toward pressure chamber 52. The end of communication flow path 54 on the side of pressure chamber 52 thus becomes larger toward pressure chamber 52. Accordingly, a flow of ink 60 is hardly hindered at the entrance of communication flow path 54 and ink 60 can be smoothly introduced from pressure chamber 52 to the mainstream portion of communication flow path 54.

As shown in FIG. 3, communication flow path 54 other than the end on the side of pressure chamber 52 is constituted by holes 413a, 414a, 415a that are circular and have the same size, and the center positions of holes 413a, 414a, 415a are identical to that of nozzle 41. As described above, the mainstream portion of communication flow path 54 connected to nozzle 41 (including a boundary of nozzle 41 and communication flow path 54) has a circular shape that is identical to that of nozzle 41 and the center of the mainstream portion is identical to that of nozzle 41. Accordingly, even when the entrance of communication flow path 54 is extended as shown in FIG. 3, a flow of ink 60 toward nozzle 41 is stabilized. Ink 60 can thus be properly ejected from nozzle 41.

While the exemplary embodiment of the present disclosure has been explained above, the present disclosure is not limited to the exemplary embodiment described above. Variations of the present exemplary embodiment are explained below.

### First Variation

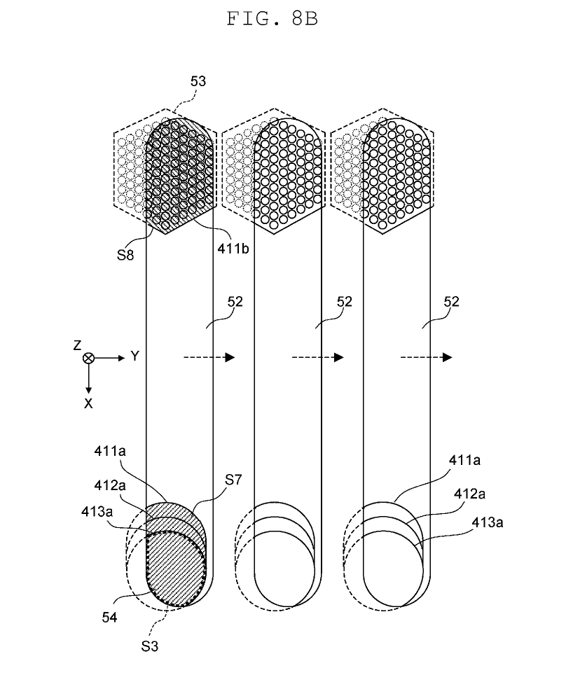

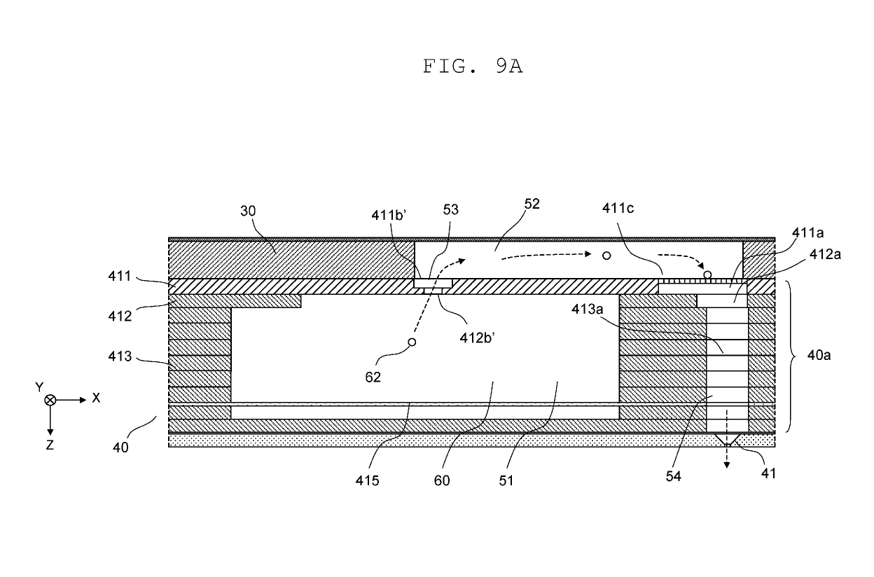

FIGS. 8A and 8B schematically show overlapping of a pressure chamber and a communication flow path according to a first variation. While the width of communication flow path 53 is increased in a direction of an X axis (first direction) in the exemplary embodiment described above, the width of communication flow path 53 (opening 411b) is increased in a direction of a Y axis (second direction) in the first variation, as shown in FIGS. 8A and 8B.

According to the first variation, even if misalignment in the direction of the Y axis occurs between communication flow path 53 and pressure chamber 52 due to misalignment of structure body 40 and actuator 30 as shown in FIG. 8B, it is possible to prevent the area of communication flow path 53 overlapping pressure chamber 52 in plan view from being reduced. As a result, similar to the exemplary embodiment described above, a flow of an ink can be secured against such misalignment.

According to the first variation, however, opening 411b is extended in the direction of the Y axis and thus, as shown in FIGS. 8A and 8B, the distance between adjacent openings 411b is very short. Therefore, when misalignment in the direction of the Y axis occurs between structure body 40 and actuator 30, as shown in FIG. 8B, pressure chamber 52 is very close to communication flow path 53 in the next nozzle set to easily communicate with communication flow path 53 in the next nozzle set.

On the other hand, according to the exemplary embodiment described above, opening 411b is extended in the direction of the X axis (first direction) and thus, as shown in FIGS. 6A and 6B, a large distance between adjacent openings 411b can be secured. Accordingly, even if slight misalignment in the direction of the Y axis occurs between structure body 40 and actuator 30, it is possible to prevent pressure chamber 52 from communicating with communication flow path 53 in the next nozzle set. As a result, an ink filled in pressure chamber 52 can be properly ejected. Therefore, it is preferable that opening 411b is extended in the direction of the X axis (first direction) as in the exemplary embodiment described above.

### Second Variation

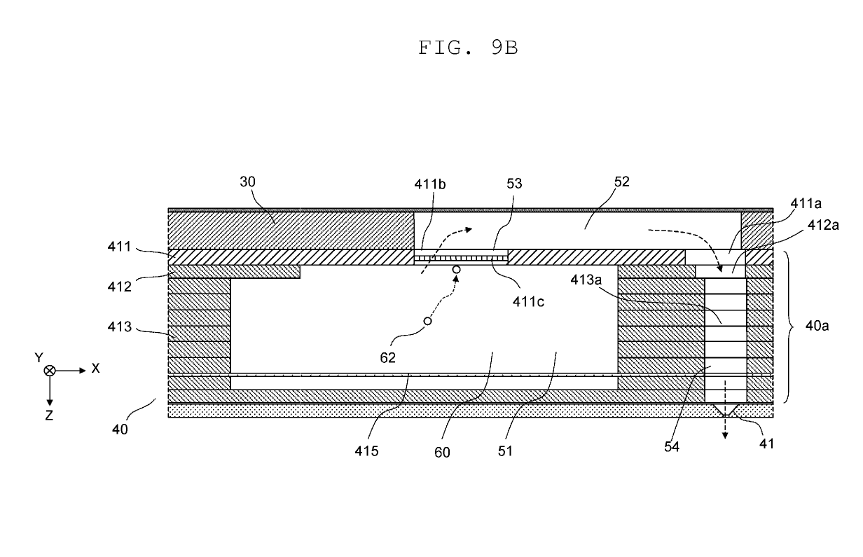

FIG. 9A is a cross-sectional view schematically showing a configuration of a communication flow path according to a second variation. FIG. 9A shows a cross-section obtained by cutting actuator 30 and structure body 40 at a center position of the width of pressure chamber 52 in a direction of a Y axis (a position corresponding to line 2B-2B of FIG. 2A) along a plane parallel to a plane X-Z. While filter 411c is provided at an entrance of communication flow path 53 in the exemplary embodiment described above, filter 411c is provided at an entrance of communication flow path 54 (a boundary of pressure chamber 52 and communication flow path 54) in the second variation. Filter 411c may be provided at other positions between nozzle 41 and the vicinity of the entrance of communication flow path 53. That is, filter 411c may be disposed at a predetermined position between nozzle 41 and the vicinity of a boundary of main flow path 51 and communication flow path 53.

According to the variation of FIG. 9A, filter 411c functions as a resistance to a flow of ink 60 flowing from pressure chamber 52 to nozzle 41 and thus in order to smoothly introduce ink 60 in pressure chamber 52 to nozzle 41, it is necessary to significantly increase the area of filter 411c. Further, according to this configuration, impurity 62 adheres to an upper surface of filter 411c and thus an operation of removing impurity 62 from filter 411c by a flow of ink 60 generated by driving actuator 30 does not work well as compared to the exemplary embodiment described above. Impurity 62 thus easily accumulates on the upper surface of filter 411c. Because of these reasons, it is preferable to provide filter 411c at communication flow path 53 as in the exemplary embodiment described above.

While filter 411c is provided in plate-like body 411 constituting communication flow path 53 in the exemplary embodiment described above, filter 411c may be disposed in a flow path by providing filter 411c in a member different from a member constituting communication flow path 53. For example, filter 411c may be disposed near the entrance of communication flow path 53 by installing a member having filter 411c formed therein from a side of main flow path 51. In such a case, filter 411c may be fitted into the entrance of communication flow path 53 or may be disposed at a position slightly shifted from the entrance of communication flow path 53 toward the side of main flow path 51 so as to cover the entrance of communication flow path 53.

### Third Variation

FIG. 9B is a cross-sectional view schematically showing a configuration of a communication flow path according to a third variation. FIG. 9B shows a cross-section obtained by cutting actuator 30 and structure body 40 at a center position of the width of pressure chamber 52 in a direction of a Y axis (a position corresponding to line 2B-2B of FIG. 2A) along a plane parallel to a plane X-Z. As shown in FIG. 9B, according to the third variation, communication flow path 53 is disposed such that the entire area of an opening of communication flow path 53 in a direction of an X axis overlaps pressure chamber 52 in plan view. As shown in FIG. 9B, filter 411c is disposed at a position shifted from an entrance of communication flow path 53 (a boundary of main flow path 51 and communication flow path 53) toward a negative side of a Z axis. Filter 411c may be disposed at an exit of communication flow path 53 (a boundary of communication flow path 53 and pressure chamber 52).

When opening 411b and filter 411c are disposed as shown in FIG. 4A, as described above, it is possible to produce the effect of preventing the pressure in pressure chamber 52 from escaping from communication flow path 53 to main flow path 51 by reducing the area of communication flow path 53 overlapping pressure chamber 52, while securing the increased area of filter 411c and increasing the flow amount of ink 60 flowing through filter 411c. Accordingly, in view of the effect, it is preferable to dispose opening 411b and filter 411c as shown in FIG. 4A.

### Fourth Variation

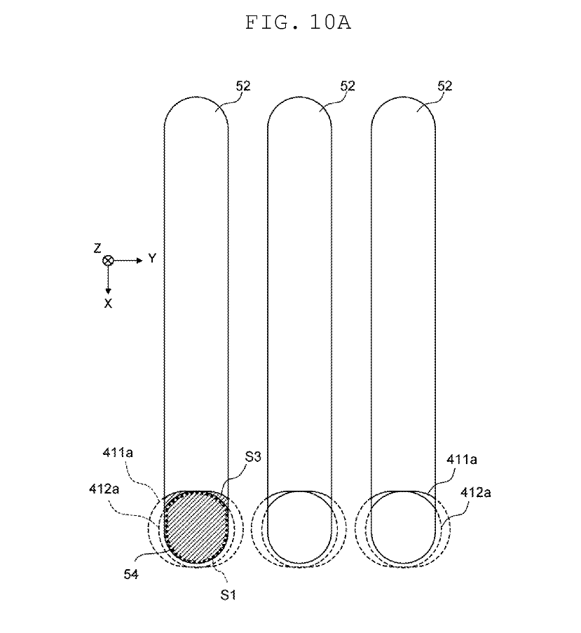

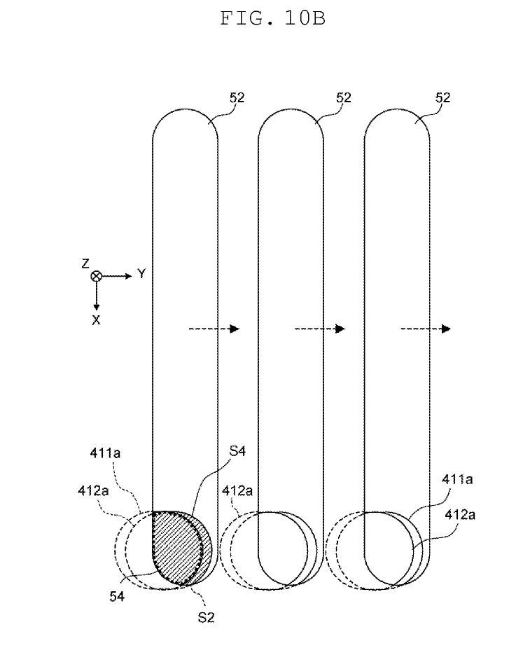

FIGS. 10A and 10B schematically show overlapping of a pressure chamber and an entrance of a communication flow path according to a fourth variation. While the width of an entrance of communication flow path 54 is increased in a direction of an X axis (first direction) in the exemplary embodiment described above, the width of the entrance of flow path 54 is increased in a direction of a Y axis (second direction) perpendicular the direction of the X axis (first direction) in the fourth variation, as shown in FIGS. 10A and 10B. Similar to FIGS. 6A and 6B, FIGS. 10A and 10B show pressure chamber 52 as perspectively viewed from a positive side of a Z axis and also show three patterns of overlapping of pressure chamber 52 and the entrance of communication flow path 54. To simplify the explanations, communication flow path 53 is not shown in these drawings.

In the fourth variation, among holes constituting communication flow path 54, only a hole of plate-like body 411 nearest to pressure chamber 52 is formed as oblong hole 411a, and a hole of second plate-like body 412 from a side of pressure chamber 52 (a boundary of pressure chamber 52 and communication flow path 54) is formed as circular hole 412a similar to holes 413a, 414a formed in third and subsequent plate-like bodies 413, 414.

According to the fourth variation, even if misalignment in the direction of the Y axis occurs between communication flow path 54 and pressure chamber 52 due to misalignment of structure body 40 and actuator 30 as shown in FIG. 10B, it is possible to prevent the area of the entrance of communication flow path 54 overlapping pressure chamber 52 in plan view from being reduced. As a result, similarly to the exemplary embodiment described above, a flow of an ink can be secured against such misalignment.

According to the fourth variation, however, oblong hole 411a is extended in the direction of the Y axis and thus as shown in FIGS. 10A and 10B, the distance between adjacent oblong holes 411a is very short. When misalignment in the direction of the Y axis occurs between communication flow path 54 and pressure chamber 52, as shown in FIG. 10B, pressure chamber 52 is very close to an entrance of communication flow path 54 in the next nozzle set and an ink filled in pressure chamber 52 may flow into communication flow path 54 in the next nozzle set. Further, an oblong hole is extended in the direction of the Y axis (second direction) in the fourth variation and thus, when structure body 40 is shifted from actuator 30 in the direction of the X axis, similar to the comparative example shown in FIGS. 5A and 5B, the area of the entrance of communication flow path 54 overlapping pressure chamber 52 is significantly reduced.

On the other hand, according to the exemplary embodiment described above, oblong hole 411a is extended in the direction of the X axis (first direction) and thus as shown in FIGS. 6A and 6B, a large distance between adjacent oblong holes 411a can be secured. Even if misalignment in the direction of the Y axis occurs between structure body 40 and actuator 30, it is possible to prevent an ink filled in pressure chamber 52 from flowing into communication flow path 54 in the next nozzle set. Further, oblong hole 411a is extended in the direction of the X axis (first direction) and thus even if misalignment occurs between structure body 40 and actuator 30 in any direction, a larger area of the entrance of communication flow path 54 overlapping pressure chamber 52 can be secured as compared to the fourth variation. It is thus preferable that oblong hole 411a is extended in the direction of the X axis (first direction) as in the exemplary embodiment described above.

With the configuration described above, the same effects can be obtained for misalignment with respect to pressure chamber 52, because opening 411b formed in communication flow path 53 is also extended in the direction of the X axis (first direction).

### Fifth Variation

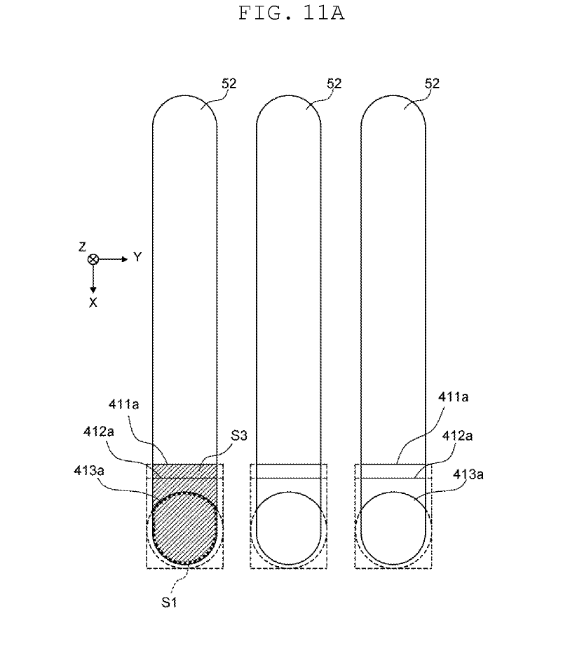

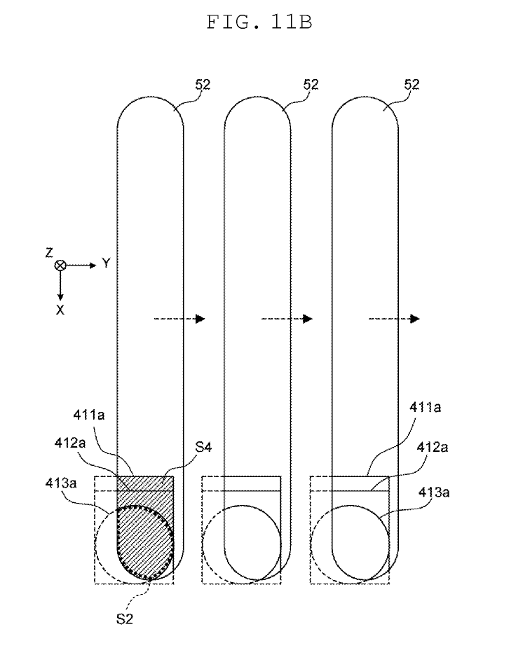

FIGS. 11A and 11B schematically show overlapping of a pressure chamber and a communication flow path according to a fifth variation. To simplify the explanations similar to the fourth variation, communication flow path 53 is not shown in these drawings. While oblong holes 411a, 412a have an oval outline as shown in FIGS. 6A and 6B in the exemplary embodiment described above, oblong holes 411a, 412a have a rectangular outline as shown in FIGS. 11A and 11B in the fifth variation. Oblong holes 411a, 412a may have other outlines expanded from a circular outline.

While oblong holes 411a, 412a are formed in a shape obtained by expanding a circle only in the direction of the X axis (first direction) in the exemplary embodiment described above, oblong holes 411a, 412a may be formed in a shape obtained by expanding a circle not only in the direction of the X axis (first direction) but also in a direction of a Y axis (second direction). As described in the fourth variation with reference to FIGS. 10A and 10B, to prevent pressure chamber 52 from being placed over communication flow path 54 in the next nozzle set, it is preferable that oblong holes 411a, 412a are extended in the direction of the Y axis (second direction) only to a certain extent.

While holes formed in first and second plate-like bodies 411, 412 from a side of pressure chamber 52 (a boundary of pressure chamber 52 and communication flow path 54) among holes constituting communication flow path 54 are formed as oblong holes 411a, 412a in the exemplary embodiments described above as shown in FIG. 3, only a first hole from the side of pressure chamber 52 may be formed as an oblong hole. Alternatively, first to third holes or first to a predetermined number Nth holes from the side of pressure chamber 52 may be formed as oblong holes.

While the size of oblong holes 411a, 412a is fixed in a thickness direction of plate-like bodies 411, 412 (a direction of a Z axis) in the exemplary embodiment described above, the size of oblong holes 411a, 412a may become smaller downward (toward a positive direction of the Z axis). An ink can thus be introduced from pressure chamber 52 to a mainstream portion of the communication flow path 54 more smoothly.

### Other Variation

While upper member 40a of structure body 40 is constituted by stacking a plurality of plate-like bodies 411, 412, 413, 414 in the exemplary embodiment described above, the method of constituting structure body 40 is not limited thereto. For example, upper six plate-like bodies 413 of seven plate-like bodies 413 shown in FIG. 3 may be integrally formed by a single member.

The configuration of ink jet head 1 and actuator 30 and the configuration and shape of main flow path 51, pressure chamber 52, and communication flow path 53 are not limited to those described in the exemplary embodiment. While an ink is supplied from two ink supply ports 30a disposed in parallel to each other in a direction of a Y axis to one main flow path in the exemplary embodiment described above, one ink supply port 30a may be provided for one main flow path.

The exemplary embodiment of the present disclosure can be variously and appropriately modified within the technical scope described in the claims.

What is claimed is:

1. An ink jet head comprising:
a pressure chamber that is filled with an ink;
a main flow path that supplies the ink to the pressure chamber;
an actuator that changes a pressure of the ink filled in the pressure chamber;
a nozzle that is connected to the pressure chamber and ejects the ink filled in the pressure chamber by driving of the actuator;
a first communication flow path that connects the pressure chamber to the main flow path; and
a filter that is disposed at a predetermined position between the nozzle and a vicinity of a first boundary of the main flow path and the first communication flow path, the filter capturing an impurity in the ink which has a size larger than a diameter of the nozzle.

2. The ink jet head according to claim 1, wherein the filter includes a plurality of holes each having a diameter smaller than the diameter of the nozzle.

3. The ink jet head according to claim 1, wherein the filter is disposed in the first communication flow path.

4. The ink jet head according to claim 3, wherein:
in plan view, the first communication flow path is disposed in such a manner that one part of an opening of the first communication flow path overlaps the pressure chamber and the other part of the opening of the first communication flow path does not overlap the pressure chamber, and
the filter is disposed on a side of the first communication flow path close to the first boundary.

5. The ink jet head according to claim 4, wherein the filter is disposed over an entire area of the opening of the first communication flow path.

6. The ink jet head according to claim 4, wherein
a width of the pressure chamber in a first direction is larger than a width of the pressure chamber in a second direction perpendicular to the first direction,
a width of the first communication flow path in the first direction is larger than a width of the first communication flow path in the second direction, and
the opening of the first communication flow path is disposed to be shifted from the pressure chamber in the first direction.

7. An ink jet device comprising:
the ink jet head according to claim 1; and
an ink supply unit that supplies the ink to the ink jet head.

8. The ink jet head according to claim 1 further comprising:
a second communication flow path that is disposed between the pressure chamber and the nozzle, wherein:
the nozzle is connected via the second communication flow path to the pressure chamber, and
an opening of the second communication flow path in a second boundary between the pressure chamber and the second communication flow path is larger than an opening of the second communication flow path in a third boundary between the second communication flow path and the nozzle.

9. The ink jet head according to claim 8, wherein:
a width of the pressure chamber in a first direction is larger than a width of the pressure chamber in a second direction perpendicular to the first direction, and
a width of an opening of the second communication flow path in the first direction at the second boundary is larger than a width of an opening of the second communication flow path in the first direction at the third boundary.

10. The ink jet head according to claim 9 further comprising:
a plurality of nozzle sets each of which includes the pressure chamber, the second communication flow path, and the nozzle, wherein
the nozzle sets are disposed side by side along the second direction.

11. The ink jet head according to claim 8, wherein an opening of the second communication flow path becomes larger toward the pressure chamber.

12. The ink jet head according to claim 8, wherein:
a structure body including the second communication flow path is bonded to the actuator so as to connect the pressure chamber to the second communication flow path,
the structure body is configured by stacking a plurality of plate-like bodies,
a hole constituting a part of the second communication flow path is formed in each of the plate-like bodies, and
an opening of the hole of a first plate-like body disposed first from the second boundary among the plurality of plate-like bodies is larger than openings of the holes of the plate-like bodies other than the first plate-like body.

13. The ink jet head according to claim 12, wherein openings of the holes of N plate-like bodies from the first plate-like body to an Nth plate-like body disposed Nth from the second boundary among the plurality of plate-like bodies become successively larger toward the pressure chamber (N is an integer equal to or larger than 2).

14. The ink jet head according to claim 8, wherein an opening of the second communication flow path at the third boundary has a circular shape having a center position identical to a center position of the nozzle.

15. An ink jet device comprising:
the ink jet head according to claim 8; and
an ink supply unit that supplies the ink to the ink jet head.
